(19) United States
(12) Patent Application Publication
(10) Pub. No.: US 2026/0320544 A1
(43) Pub. Date: Oct. 15, 2026

(54) BULK PURCHASE VIRTUAL INVENTORY SINGLE PIECE TAKE-HOME SALES SYSTEM

(71) Applicant: Masahiro KOKO, Tatsuno-shi (JP)

(72) Inventor: Masahiro KOKO, Tatsuno-shi (JP)

(21) Appl. No.: 19/481,111

(22) PCT Filed: Apr. 10, 2025
(86) PCT No.: PCT/JP2025/014394

§ 371 Date: Nov. 3, 2025

(30) Foreign Application Priority Data
Apr. 11, 2024 (JP) 2024-064298

(51) Int. Cl. G06Q 10/087

(52) U.S. Cl. CPC G06Q 10/087

(57) ABSTRACT

A virtual stock system eliminates excessive inventory and overproduction and enables construction of a system for retailing stores that can be purchased at low cost without inventory at home. First, the problem of identifying the goods at the cash register is solved by using the inventory record updated signaling and checking with the identity of the owner of the bulk purchased goods and the merchandise confirmation of the bulk purchased goods. At the same time, the risk of reducing the profit at the retailer, which is the second problem, is solved by the system for adjusting the purchase prices. This provides a sales system which is useful not only for consumers but also for stores and manufacturers by adopting a virtual stock system in a system for taking home from time to time in a bulk purchase shop in a tangible commodity which is not an intangible service.

### TECHNICAL FIELD OF INVENTION

The present invention relates to a system for separately taking out or taking back one of bulk purchase goods or products kept under virtual stock control, as needed by the customer C from a store B where real goods or products are displayed for sales.

### BACKGROUND OF THE INVENTION

The most important point of sales is in that consumers can obtain high-quality products at low prices, while retailers do not have excessive inventory that leads to low prices, so that they can achieve maximum sales under minimum fair inventory. As one of the promotion ways for buying and selling goods, the bulk purchase in advance has been proposed, and it has been practically used in the alcoholic bottle keeping system and the coupon ticket system since long ago. Because such a bulk purchase in advance system is a discount buying system for customer while the bulk purchase can keep a continuous selling merit for shop or seller without excessive inventory, so that it is a convenient trading system for both. In the case where the product is an intangible service such as the alcoholic service, since buying and selling process is done in a face-to-face manner in the relationship between the consumer and the service provider, there is no problem of the product inventory, and therefore, it is easy to implement the service system such as the bottle keeping or the coupon ticket system under the relationship between the two parties. Therefore, a system has been proposed in which a virtual bottle system is installed and can be commonly used in a chain store, and can be used in a certain food and drink as a common ticket within a certain range even in the same store (Patent Document 1).

### PRIOR ART

### Patent literature

Patent Document 1: JP-A-2022-167252

### SUMMARY OF THE INVENTION

### Problems to be Solved by the Invention

However, different from the provision of intangible services such as bottle keeping system, in the case of sales of tangible real goods, a bulk purchase discount system has been performed by direct purchase from a Producer or Manufacturer A by net sales. Usually, separate product purchases are expensive to transport, so Consumers C often need to buy the product in bulk and stock them at home. However, the problem of increased home inventory and transportation costs is disadvantageous to Consumers C, which comes to a heavy limitation of online sales. Therefore, the usual present distribution route where the products are wholesaled from Manufacturer A to Distributor B and separately taken back by Consumer C from the Distributor B, is recommended as a very useful way. In order to promote a system of purchasing products at a discount price through a bulk purchase in such a useful route, first, 1) it is preferable that the consumer C can take the products out of the retail store at any time without having to stock them at home. However, in this case, the retailer is likely to have excessive inventory and has a risk of leading to a low price. In other words, in the principle of buying and selling, WIN-WIN relations are desirable, and consumers C want to buy goods at as much discount as possible, while retailers B do not want to have excessive inventory that leads to low prices. Therefore, in order to solve such a problem and to have a WIN-WIN relation between the consumer C and the retailers B, it is preferable that the seller or retailer B does not have excessive inventory, and the consumer C uses the bulk purchasing discount system. According to an embodiment of the present invention is to provide a sales method that allows consumers C and sellers B to have WIN-WIN relationships with each other, that is, to enable consumers C to purchase at a discount price that is cheaper by means of a bulk or lump-sum purchase contract, and to enable consumers C to purchase at a discount price without requiring transportation expenses by taking back from the store or retailer B at any time, while the retailer B does not have an excessive inventory even under the bulk purchase contract and does not lead to a reduction in profits even if sold at a discount price.

### SUMMARY OF THE INVENTION

As a result of intensive studies to solve the above problems, the present inventors have focused on the following points. It is recommendable for the consumer C to makes a bulk purchase for a discount, while the retailer B is better able to separately take home to the consumer C under the minimum proper inventory, therefore in order for the consumer C and the retailer B not to have more than necessary inventory of goods, the best way is to allow the retailer B to be able to predict the consumption trend not for making a real stock but for making a virtual stock. However, when the retailer B introduces a virtual inventory system, the following problems are likely to occur. First, 1) since not only the bulk purchased commodity but also the general commodity are simultaneously placed and traded at the same selling position, it is necessary that the store or retailer B distinguishes whether the commodity to be purchased is one of the bulk purchased or not the bulk purchased at the time of the settlement. If the purchasing commodity is separately sold before settlement, it will lead to the quality degradation easily. This is because it is not a good idea for margin trading of products. Second, 2) if the bulk purchase discount system is adopted, there is a concern that the profit of the retailer B will be lower than that of the sale of general goods. This is because the trading profit of the bulk purchased product is lower than the profit of the general purchased product. Therefore, it is necessary to lower the purchase price from the manufacturer A, but it is difficult to distinguish the purchase price between general purchased products and bulk purchased products for wholesale. The present inventor, since 1) the problem of the first product identification is updated at the time of separate takeout of the commodity inventory which has always been purchased collectively in the virtual stock, such updated signal is utilized at the time of commodity settlement, it was focused on that it can be solved by confirming the identity and confirming the commodity. 2) The second problem of the decrease in profits from trading is that the inventory control and production control become easier due to the bulk purchase contract, and the loss due to the discount caused by the overproduction and the excess inventory is eliminated. Therefore, the problem can be solved by adjusting the wholesale prices of the products according to the number of contracts for the collective purchase.

The present invention is in realizing a WIN-WIN sales system which can be carried out by adopting a virtual stock in a sales system, and can carry out the inventory management of bulk purchase goods, a Manufacturer A manufactures the goods G, and the store B displays and sells the goods G, and the customer C purchases the display goods G at the store B. In an actual commodity distribution sales route in which the customer C purchases the display goods G at the store B, the customer C makes a bulk or bulk purchase contract with the manufacturer A or the store B, carries out virtual stock of the goods G which paid up in advance, and carries it out separately as needed from the store B. It consists of a portable terminal, such as a smart phone of the customer C, a two-dimensional code for commodity sale of the store B, and a managing server of the manufacturer A. A management server of the manufacturer A or the store B receives the member registration signal S 1 from the mobile terminal of the customer C to form a virtual stock, and a system for receiving the bulk purchase signal S2 of the customer C via the mobile terminal of the customer C to record the bulk purchase product quantity in the virtual stock, The customer C reads the two dimensional code for merchandise sale of the store B via a mobile terminal, and transmits the customer's C separate takeout signal S3 to the managing server of the store B or a manufacturer A. In response to this, the inventory record of the virtual stock is updated, and the inventory record updated S4 of the commodity G 1 is transmitted to the register of the store B. The store or retailer B is in a batch purchasing virtual stock separate takeout system comprising: a cashier; and a system for checking the inventory record-updated signal S4 of the virtual stock received from the managing server, the identity confirmation in the portable terminal application, and the commodity code attached to the commodity, and for distinguishing the commodity from the common commodity and settling the payment. In the present invention, one of the distributor or store B and the manufacturer A may share the management server to manage the virtual stock, but the distributor or store B and the manufacturer A may each have a management server to manage the virtual stock. It is preferable to adjust the inventory management, the production management, and the purchase price by the management of the virtual stock based on the data on the number of stocks and the number of retail sales for the bulk purchased commodity.

### Effect of the Invention

According to the present embodiment, the sales by the virtual stock can be performed as follows, that is, after performing the identification by reading the membership application or the like at the shop register and the commodity confirmation by reading the commodity code of the takeout commodity, the virtual stock record of the commodity purchased collectively at the management server is updated, and the inventory commodity record updated signal S4 is received, and the separate takeout is approved by collating them, so that it is possible to perform the settlement by distinguishing the bulk purchased commodity from the common commodity, and thus it is possible to realize the bulk purchase stock separate takeout sales.

That is, first, 1) the retailer B or the manufacturer A holds a management server and introduces a bulk or bulk purchase system by introducing a virtual stock system while sharing data. Therefore, the retailer B is able to purchase products at discounted prices at the cash register and take them back from the retailer B at any time while the retailer B is free from the over-inventory and the manufacturer A is free from overproduction issues. There is no problem with the inventory at home, and the distribution route of WIN-WIN that will benefit both sides will be formed. Second, 2) the shop needs to identify and liquidate the general commodity and the bulk purchased commodity at the register, but using the updated signal S4 at the register, it is possible to identify and distinguish the take-out commodity from the general commodity by checking the commodity code attached to the takeout commodity, even if the bulk purchased commodity is mixed with the general commodity.

Third, 3) it is difficult for manufacturers A to distinguish the wholesale price (purchase price) between general products and bulk purchased products. Therefore, there is a concern that the retailer B may reduce the merchandise sales profit by selling the bulk purchased merchandise. On the other hand, in case that the bulk products can be distinguished from general products before take-out, it is likely to lead to quality deterioration of the bulk products. According to the present invention, by introducing a purchase price adjustment system into a virtual stock system introduced by a management server, it is possible to eliminate the concern of a decrease in profit of a shop, and it is easy to adopt a bulk purchase virtual stock system. That is, the management server allows the manufacturer A to know the number of stocks N and the number of takeovers at the retailer B, so that the purchase price can be adjusted according to the number of stocks, the number of takeovers, and the like, thereby suppressing a decrease in the profit of the retailer B due to the coexistence of the general purchase and the bulk purchase. For example, it is possible to adjust the purchase price by reducing the wholesale unit price by Na % according to the number of stocks N, and by providing a purchase price adjustment system for retailer B to return according to the number of separate takeout. As a result, the retailer B can try to increase virtual stock sales and avoid a decrease in the profit due to the bulk purchase system (see FIG. 9).

Further, since the virtual stock system is introduced into the management server, the store or retailer B can perform inventory management by the virtual stock number N and the virtual stock number M. Since the production management can be performed by the manufacturer A by using the virtual stock number N and the virtual stock number M of the store B, it is possible to avoid a low discount sales due to excessive inventory or excessive production.

Furthermore, by adopting the virtual stock system, the store B headquarter can share data from C1 to Cn of customers per stores B 1 to Bn, so that the store headquarter can control the chain store. Therefore, according to the embodiment of the invention, it is advantageous to solve a variety of issues in bulk purchasing.

According to the virtual stock system of the present invention, specifically, the store B is provided with a QR cord (Registered Trademark) system 100 consisting of 101 and 102, while the Customer C is provided with a product purchasing system 200 in a mobile terminal 200A such as a smartphone and also the manufacturer A is provided with a product management system 300 composed of a server 300A and 300B, and the register at the store B is provided with a product settlement system 400 to the register. The sales system 100 includes three types of QR code displays: a member registration code QR1 for transmitting a signal S1 for performing member registration; a collective purchase code QR2 for transmitting a signal S2 for performing a bulk purchase of goods G; and a goods separate take out code QR3 for transmitting a signal S3 for performing a goods separate take out of a member.

The merchandise purchasing system 200 includes a means for transmitting a QR code read by an QR code reader 200 to a mobile terminal 200A such as a smartphone owned by a customer C. The mobile terminal is provided with (1) a screen which displays the member application icon 202 obtained by reading the aforementioned membership registration code QR1 and transmitting a membership registration signal S1, (2) a device which reads the member goods bulk purchase code QR2 and transmits merchandise bulk purchase signal S2, (3) a device which reads the member separate sales code QR3, and transmits another takeout signal S3.

The management system 300 consists of a server 300A and/or a 300B of the manufacturer A and the distributor B, and is provided with (4) a virtual stock device that receives the member registration signal S1 from the customer C and forms virtual stock 301, 302 and 303 for each of the customer C, (5) a recording device that receives the stock S2 of the virtual stock 301, 302 and 303, and (6) a device that receives the separate take-off signal S2, and (7) an inventory record updating device of the virtual stock 301, 302 or 303, (8) a device that sends an inventory record-updated signal S4 to store B and customer A terminal,

The adjusting system 400 in a store B register which cooperates with the server 300A of the manufacturer A or server 300B of the store B, is provided with an adjusting device which discriminates a bulk purchase commodity and another general commodity by collating the identity confirmation of the customer C with the commodity confirmation, and excludes the bulk commodity from the commodity settlement item and calculates it, is provided with (9) a receiving equipment which receives updated signal S 4, transmitted from the managing server 300A or 300B. According to the embodiment of the present invention, it is preferable to attach the commodity code QR3 for separate takeout to the commodity container for the settlement operation at the cash register. In addition, in the present invention, it is preferable that the store B and the manufacturer A share the data of the stock number and the separate takeout number, to make a purchase price adjustment system.

In the present invention, in order to perform membership registration of the sales system 100, the first code displaying the member registration code QR1 for transmitting the signal S1 of the signal, or the second code displaying the collective purchase code for transmitting the signal S2 may be obtained via the Internet, and the member registration or the member registration and the collective purchase contract may be performed.

### BRIEF DESCRIPTION OF THE DRAWINGS

FIG. 1 It is a diagram showing each process system (a) and each process procedure constituting the virtual stock sales method according to the present invention.

FIG. 2 In the virtual stock sales method according to the present invention is a relationship diagram showing a relationship between each system and a process in the case where the virtual stock is managed by the manufacturer.

FIG. 3 In the virtual stock sales method according to the present invention is a relationship diagram showing the relationship between the respective systems and the process in the case where the virtual stock is managed by the store.

FIG. 4 In the virtual stock sales method according to the present invention, it is a relationship diagram showing the relationship between each system and the process in the case of managing the virtual stock at the store and the store head office.

FIG. 5 In the virtual stock selling method concerning the present invention, it is a relation diagram showing the relation between each system in the case of managing a virtual stock by a sales headquarters and a manufacturer, and a process.

FIG. 6 It is a 1st example of the system which carries out the virtual stock selling method of FIG. 1, and is made While the original A forms a virtual stock of the customer C, the customer C in the store B is a schematic diagram showing a method of settlement at the register in bulk purchase unit price to identify the general product when bringing back a part of the collectively purchased product.

FIG. 7 is a second example of the member virtual stock sales method according to the present invention implemented by the configuration of FIG. 1, in which the store B forms a virtual stock, and the manufacturer A integrates the virtual stock of Bn from the plurality of store B 1, while at the store B, the customer C is a schematic diagram showing a method of identifying the general commodity as the general commodity and settling the payment at the cash register at the lump-sum purchase unit price when bringing back a part of the lump-sum purchase commodity.

FIG. 8 is a third example of the member virtual stock selling method according to the present invention implemented by the configuration of FIG. 1, in which the distributor B forms a virtual stock, and the manufacturer A and the distributor B headquarters integrate Bn virtual stocks from a plurality of distributor B 1, while the customer C at the distributor B is a schematic diagram showing a method of identifying the purchased commodity as a general commodity and settling at a cash register at a lump-sum purchase unit price when the customer C carries a part of the lump-sum purchased commodity.

FIG. 9 is a process diagram of a purchase price adjustment system used in the present invention.

### DETAILED DESCRIPTION OF THE INVENTION

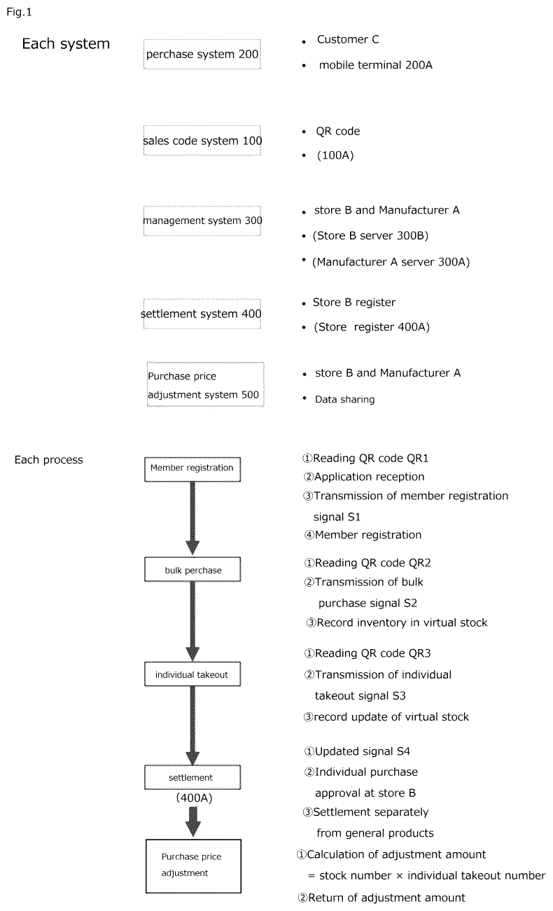

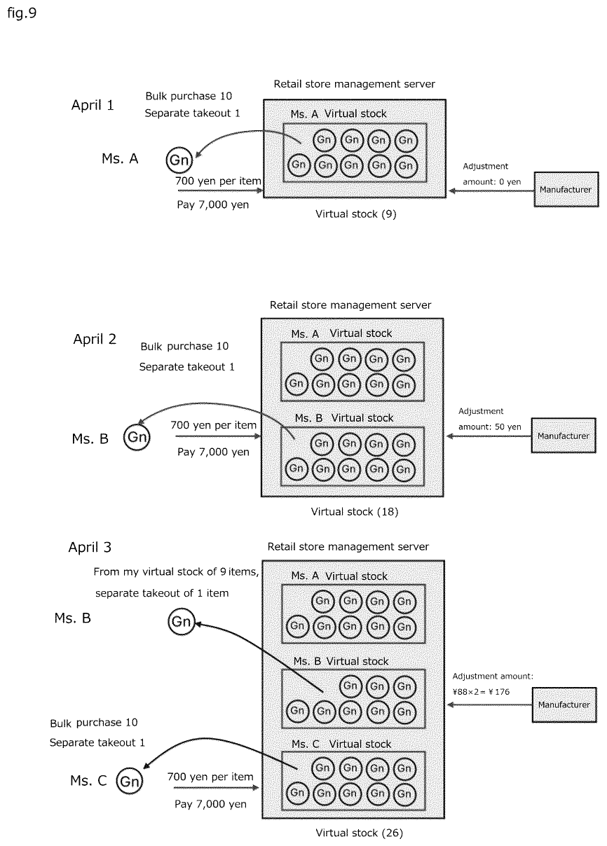

The sales method by the virtual stock system concerning the present invention is shown in FIG. 1(b) which comprises 1) member registration process, 2) bulk purchase process, 3) separate purchase process, 4) settlement process, and 5) purchase price adjusting process. In the member registration process, QR code QR1 is read, the application is received, and the member registration signal S1 is transmitted to perform member registration. Then, in the bulk purchase process, QR code QR 2 is read, and the bulk purchase signal S2 is transmitted and the inventory is recorded in the virtual stock. In the separate purchasing process, QR code QR3 is read, the separate takeout signal S3 is transmitted, and the inventory records of the virtual stocks are updated. In the settlement process, the Manufacturer A or the Distributor B that received the separate takeout signal S3 transmits the updated signal S4 to Register of the Distributor B, and performs the settlement at the bulk purchasing unit price by checking with the identity check and the merchandise check and distinguishing it from ordinary merchandise. In the register, identification by reading a registered application or the like is used for 1) the settlement signal S5, and 2) the commodity identification is performed by checking the commodity confirmation by reading 3) the commodity code attached to the commodity. In addition to the membership application of the mobile terminal, the identity confirmation includes an updated signal S4 transmitted to the mobile terminal of the customer C. The purchase prices for the bulk purchases are adjusted using the control server 300A and 300B of the Manufacturer A and the Distributor B. For example, the adjustment step shown in FIG. 9 is performed. This process is performed by a sales system 100 composed of product QR code 100A shown in FIG. 1(a), and a purchase system 200 composed of a mobile terminal 200A of Customer C. The management system 300 consisting of the server 300A and 300B of the manufacturer A and the store B, the settlement system 400 and the management server 300A and 300B including the store register 400A placed in the store register, and the management data are shared and executed by the purchase price adjusting system 500. Since the purchase price adjustment system 500 is a common system and is carried out in the process shown by FIG. 9, while the other processes; 1) membership registration process, 2) the bulk purchase process, 3) the separate purchase process, and 4) the settlement process are divided as follows.

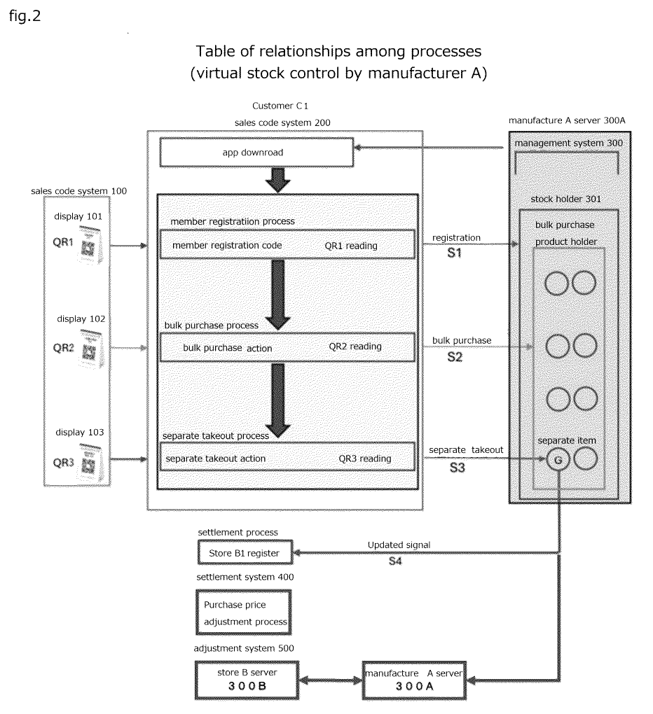

In the first embodiment, when the virtual stock is managed by the manufacturer A, as shown in FIG. 2, the member C1 uses the purchasing system 200 to read the two-dimensional code display object QR1 of the selling system 100, and sends the signal S 1 to the manufacturer A server 300A of the managing system 300, the member is registered, and then the customer C1 uses the purchasing system 200 to read the two-dimensional code display object QR2, for bulk purchase, and after the payment, then, the signal S2 is transmitted, so that the manufacturer A server 300A stores the stock in the virtual stock holder 301. A customer C 1 (or may be a retailer register) uses the purchasing system 200 to read and separately buy the two-dimensional code indication QR3 of the retail system 100, and upon separate purchase, an separate return signal S3 is sent to the Managers A Server 300A of the Administration System 300 to update the records of the virtual stock holder 301, and an updated signal S4 is sent to the retailer register of the settlement system 400 for use in the bulk purchase price settlement process.

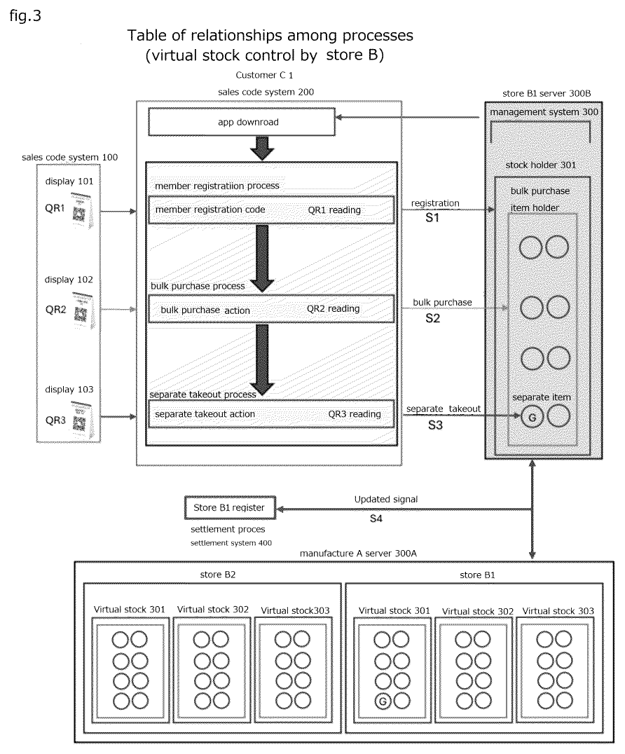

In the second embodiment, when a plurality of store B 1, B 2 . . . and the manufacturer A manage the system, the customer C1 reads the two-dimensional code display object QR 1 of the sales system 100 using the purchase system 200 and the membership is registered when the signaling S 1 is sent to the server 300B of the store B in the management system 300, and the customer C1 then reads the two-dimensional code display object QR2 using the purchase system 200, as shown in FIG. 3. When collectively purchased and settled, the signal S2 is transmitted, the server 300B of the store or distributor B record the stock in the virtual stock holder 301, the customer C1 (or the store B register) uses the purchasing system 200 to read the two-dimensional code display object QR3 of the selling system 100, and when separately purchased, the signal S3 is sent to the distributor B server 300B of the administration system 300 to update the records of the virtual stock holder 301, then the updated signal S4 is sent to the distributor register of the settlement system 400, in the settlement process is cleared at a bulk purchase price by using the updated signal S4. Here, when the store B is not a chain shop, the manufacturer A may also include a server 300A that manages data of each store, and the manufacturer A may share and manage data of each store B1 and B2.

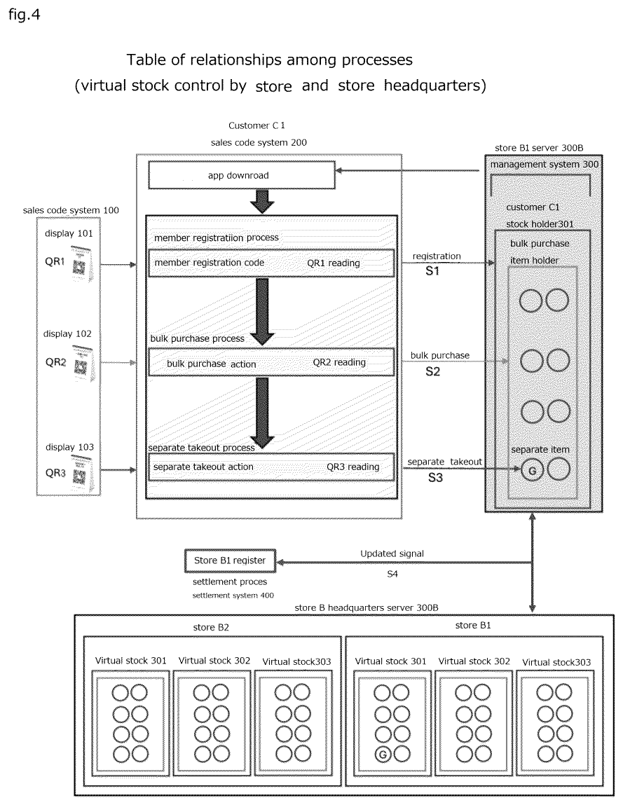

In the third embodiment, when the store or distributor B is a chain store, the virtual stock may be managed not only by each distributor B but also by the distributor headquarters. As shown in FIG. 4, the member C1 reads the two dimensional code display object QR1 of the sales system 100, and sends a signal S 1 to the sales store B server 300B of the management system 300, then the member registration is carried out, and when a customer C1 reads a two dimensional code display object QR2 and carries out bulk purchase and settlement, a signal S 2 will be transmitted, and the customer C1 (or sales store register) will read the two dimensional code display object QR3 of the sales system 100 using the purchase system 200, and a signal S3 will carry out separate purchase. The records of the virtual stockholders 301 are updated and the updated signal S4 of the inventory records are sent to the store register of the settlement system 400, where the settlement process utilizes the updated signal S4 to be settled at the bulk purchasing price. Here, each store B and its headquarters are provided with a server 300B, and data of each store is shared with the headquarters.

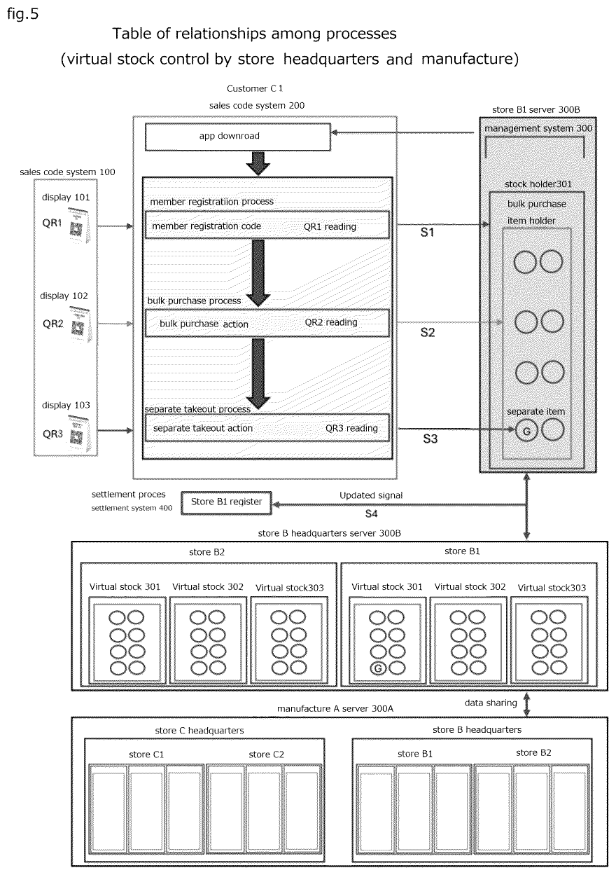

In the fourth embodiment, when the store B headquarters and the manufacturer are provided with the server 300B and the server 300A together with the stores B, the system of FIG. 3 and the systems of FIG. 4 are integrated as shown in FIG. 5. In short, the system is configured to manage virtual stock sales by having the management system 300 by at least one of the distributor B (in the case of a chain, the distributor headquarters) and the manufacturer A. That is, the embodiment of the present invention, is a system comprising 1) after the member registration a virtual stock sales system is formed on the basis of the bulk purchase contract, and 2) the customer C purchases one of the bulk purchase product G at the store B separately at the bulk purchase unit price and brought it back to home, which is provided with the sales system 100, the product purchase system 200, the product management system 300, and the product settlement system 400 are implemented, and QR code display material 1 0 OA, the mobile terminal 2 0 OA such as a smartphone owned by the customer C, the server 300A owned by the manufacturer A and the server 300B of the store B. Note that, although one takeout is described as an example in this specification, it is needless to say that the present invention can be applied to a plurality of takeouts.

The QR code display object 100A is a configuration for implementing the sales system 100, comprising three QR code displays, where the display object 101 is a member registration code QR1 for transmitting a signal S1 for member registration, the display object 102 is a bulk purchase code for transmitting a signal S2 for performing a commodity bulk purchase of a member and the display object is a commodity separate takeout code for transmitting a signal S3 for performing commodity separate takeout of a member (usually, in preparation for reading at a register, a code for separate takeout is also attached to the commodity itself).

A portable terminal 200A such as a smartphone owned by the customer is configured to implement the commodity purchase system 200 of the customer C, and includes a means for transmitting a signal of QR code read by QR code reader 201, which is provided with (1) a screen for displaying a member application icon 202 obtained by sending the read member registration signal S1; (2) a device for reading the member commodity bulk purchase code QR2 and transmitting the commodity bulk purchase signal S2; (3) a device for reading the member separate purchase code QR3 and transmitting the separate purchase signal S3.

The server 300A of Manufacturer A and the server 300B of the distributor B are configured to implement the administration system 300, and (is provided with 4) a device that receives the member registration signal S1 from Customer C and makes virtual stocks 301, 302 and 303 for each Customer C. The administration system 300 is also provided with (5) a recording device which receives the bulk purchase signal S2 of the customer C and records the stock in the virtual stocks 301,302 and 303, (6) a device which receives the separate takeout signal S3 from the customer C, (7) a device which updates the inventory record of the virtual stocks 301, 302 or 303 by the separate takeout signal S3, and (8) a device which transmits the purchased update signal S4 of the commodity G1 to the mobile terminal of the customer C at the register of the sales store B, and manages the virtual stock record.

The server 300B of the store B not only manages the above-mentioned virtual stock record, but also has a system for carrying out the settlement system 400 at the time of a customer's goods purchase settlement of accounts at a register, is provided with (9) a receiving unit which receives the updated signal S4 from the customer C or the manufacturer A, and an adjusting device which distinguishes the purchased goods from other common goods in response to the updated signal S4, Here, in the settlement device, the updated signal S4 is used to confirm the identity of the user by the member application of the mobile terminal of the customer B and to check the updated signal S4 by reading the separate takeout code QR 3 attached to the commodity, whereby the bulk purchased commodity and the general purchased commodity can be reliably identified and cleared.

When a store B is one of chain stores, the management system 300 is often managed by each chain store and the store headquarters, and based on the customer C's bulk purchase contract for product G, the store and headquarters B form virtual stocks, while customer C can separately carry out the bulk purchase of product G at the unit price at the store B according to a virtual stock sales system. In this case, the system configuration is provided with the sales system 100, the merchandise purchase system 200, the merchandise management system 300, and the merchandise settlement system 400, which comprises QR code indications 101 and 102, the portable terminal 200, such as a smartphone owned by customer C, and the server 300 owned by the stores and the store headquarter B. In this case, the manufacturer A may also include a server 300A to share the data with the headquarter B.

QR code display object is a configuration for implementing the sales system 100, which comprises a first QR code display object 1 0 1 for displaying a member registration code QR 1 for transmitting a signal S1 for performing member registration, a bulk purchase code QR2 for transmitting a signal S2 for performing commodity bulk purchase of a member and a commodity separate carry-back code QR3 for transmitting a signal S3 for performing commodity separate carry-back of a member. QR3 is also attached to a commodity. TSince the membership registration and the bulk purchase can be separately carried out at a place other than the store, when the customer registers the membership and the bulk purchase via the Internet outside the sales store, holds the membership registration application, and holds the inventory record in a portable terminal such as a smartphone, the separate purchase can be separately carried out at the bulk purchase unit price by reading code QR3.

A mobile terminal 200A, such as a smartphone owned by the customer, is configured to implement the merchandise purchase system 200 of the customer, and includes a unit that transmits a signal of QR code read by the code reader 201, which comprises (1) a screen that displays a member application icon 202 obtained by reading the membership registration code QR 1 and transmitting the membership registration signal S 1, (2) a device that reads the membership bulk purchase code QR2 and transmits a merchandise bulk purchase signal S2, and (3) a device 203 for reading the membership separate sales code QR3 and transmitting an separate takeout signal S3.

The server 300B of the distributor and the distributor head office B is configured to implement a management system 300 of a distributor, and (4) a virtual stock device for forming a virtual stock 301,302 and 303 for each customer C by receiveing the member registration signal S1 from the customer C, and (5) a recording device for that receives a batch purchasing signal S2 of the customer C and, (6) a device for recording the stock in the virtual stock by receiveing an separate take out signal S2 from the customer C, and (7) an update devise for updating the inventory records of the virtual stock 301,302 or 303 by the separate take out signal S3, and (8) a device for transmitting a purchased signal S4 of a commodity G1 to a store B.

The server of the store B is a devise for carrying out the adjustment system 400 at the time of a customer's goods purchase settlement of accounts at a register, which comprises (8) a receiving unit which receives the updated signal S4 from the manufacturer A, and/or the settlement of accounts signal S5 from the customer C. A virtual stock sales system comprises a checkout device for checking a commodity confirmation signal obtained by reading a personal identification signal (which may be a settlement signal S5) from a member application and a commodity code QR3 attached to the commodity, whereby identify the purchased commodity and another common commodity, and exclude the purchased commodity from the commodity checkout item for settlement.

The server 300B of the store B is preferably a combined facility that executes a virtual stock sales system having (9) a settlement device that receives the settlement signal S5 and the commodity confirmation signal (the signal S3 of the separate takeout code QR3) from the customer C together with the updated signal S4 to identify and settle the collectively purchased commodities and other common commodities.

Further, the server 300A of the manufacturer A is preferably a combined facility that executes a virtual stock sales system including a device that receives the total amount of the commodity G 1 bulk purchase-signal S2 from the customer C 1 to Cn for each store from the sales shop B 1 to Bn and receives an order from the sales shop B 1. This is because the annual production plan is easy to make.

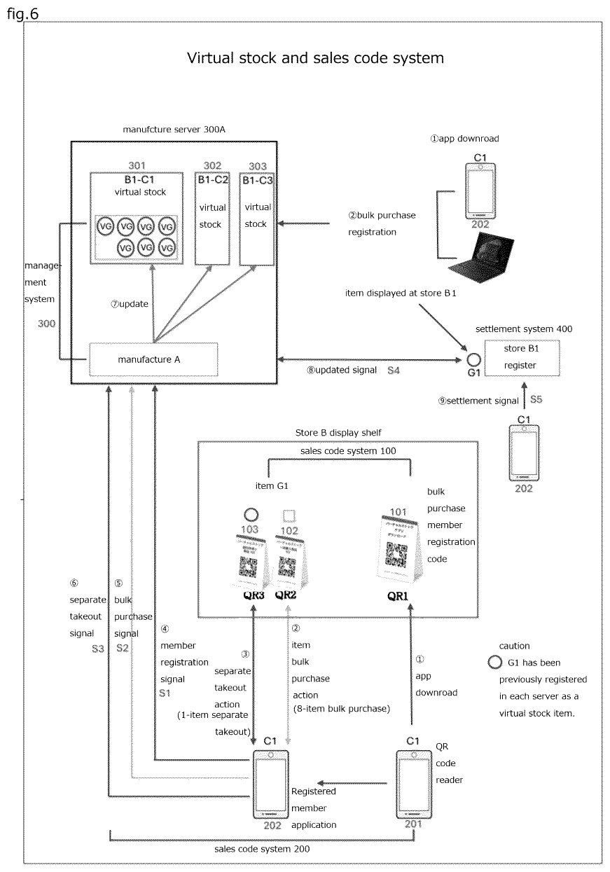

(Example 1) FIG. 6 shows the 1st example of the present invention, and the customer C carries out membership registration and obtains a membership application. Based on the bulk purchase registration of the commodity G, the manufacturer A registers this to form a virtual stock and records the inventory, while the customer C implements the virtual stock sales method in the case where the bulk purchase commodity G is brought back at the bulk purchase unit price at the store B.

Distributor B is equipped with QR code indicators 101 and 102, which implements the following distribution system 100. That is, while being provided with the bulk purchase member registration code QR1 in a commodity corner and being provided with the commodity bulk purchase code QR2 in the neighborhood, a quotient One separate take-out cord QR3 is attached to each item. Therefore, the customer C can obtain a member application via (1) member registration-code QR1, and then the customer C can (2) When a lump-sum purchase contract (including payment) is made via the lump-sum purchase code QR2 via the member application, the lump-sum purchase product is virtually stocked in the virtual stock (at the same time, a virtual stock may be formed in the store B). (3) Distributor B can sell the product to Customer C at a lump-sum purchasing unit price via a separate takeout code QR3.

The customer C includes a mobile terminal 200A such as a smartphone including QR code reader 201, and executes the following purchasing system 200. That is, (1) the member registration-code QR1 in the store B is read through the mobile terminal 201 such as a smartphone, to obtain the member app, and transmits the member registration signal S1, so that the member registration can be carried out. A virtual stock of the customer C is prepared by the membership registration. The membership registration is not limited to this, and can be realized by searching an application and a web method on the Internet and obtaining the membership application or displaying the web method on PC. Subsequently, if a customer c carries out bulk purchase registering via bulk purchase code QR2 via a member application, apart from the member registration signal S1, the bulk purchase signal S2 is transmitted to the manufacturer A, and the inventory is recorded from the separate virtual stock 301 (B1-C1 to 303 (B1-C3). After that, the customer C views the commodity G 1 and enters an separate takeout operation from the separate sales code QR3 (which can also be performed at the time of settlement at the cash register), the separate takeout signal S3 is transmitted to the manufacturer A.

Manufacturer A has a server 300A and implements the following administrative system 300. As mentioned above, if bulk purchase signal S2 from the customer C is received and it will be bulk purchase registration. Subsequently, (3) When the separate takeout operation is started by reading the member separate sales code QR3 by the member registration application of the customer C, (6) the separate takeout signal S3 is received from the customer C, (7) the manufacturer A updates the recording of the virtual stock, and (8) an updated signal S4 of the commodity G1 is sent to the sales store B and the customer C. The operations of (6) to (8) may be usually performed at the time of settlement at the cash register.

The Distributor B further implements the following settlement system 400 for checkout at the Distributor 300B. That is, (8) upon receiving the updated signal S4 from the manufacturer A, the updated signal S4 from the manufacturer A of the customer C is collated with the settlement signal S5 for the identity confirmation and for the bulk purchase product confirmation, so that the bulk purchased product is excluded from the necessary settlement item at the time of the product settlement. Here, the updated signal S4 from the manufacturer A is used when the inventory of the virtual stock is updated by the separate takeout signal S3 of the customer C as the updated signal S4. The signal S3 is sent from the manufacturer A to the store B and the customer C as the updated signal S4, so that the signal S4 is used to makes the separate take out item excluded from the item to be paid at the register. When the checkout may be a collating of 1) the updated signal S4 of the inventory record, 2) the settlement signal S5 from the mobile terminal application of the customer C for the identification, and 3) QR code QR3 attached to the commodity at the shop register, (9) the member application of the customer C is requested to transmit the checkout signal S5 to the store, so that the separate take out product can be excluded from the checkout target. In the case of the virtual stock sales, since the virtual stock 301, 302, and 303 are formed by receiving the bulk purchase signal S2 together with the member registration A, and the inventory records of the virtual stock are updated by the separate takeout signal S3, the updated signal S4 may be used to make the separate takeout product excluded from the cash register payment target of the distributor B.

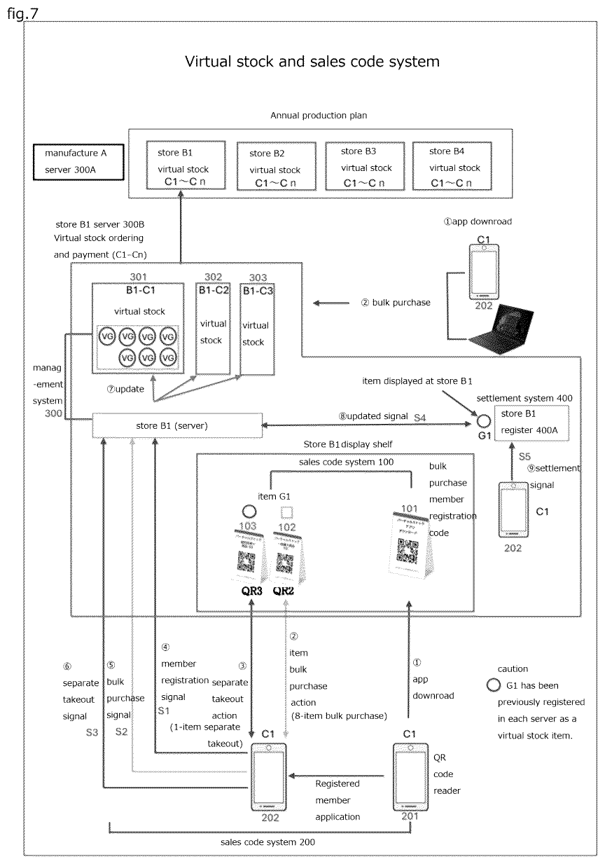

(Example 2) In the second example of the present invention, as shown in FIG. 7, the store B forms a system of virtual stock and records the stock based on the membership registration and the bulk purchase of the product G of the customer C. In addition, the manufacturer A can collect bulk purchasing records from the retail stores B1 to Bn and stores the records in a virtual stock by the server 300B of the store B. In this case, the customer C can bring the bulk purchased product G back at the bulk purchased unit price at each of the stores B1 to Bn in the same manner as in the first example, but the virtual stock can be performed in each of the stores B1 to Bn. In this case, the Manufacturer A can supply the products to the stores B1 to Bn by receiving the order from the stores B1 to Bn, so that the system construction can be simplified. Other sales code system 100, the purchase system 200, the settlement system 400 is the same as the first example, it is different from the Example 1 in that the management system 300 can be performed by not only store B, but also by the manufacturer A.

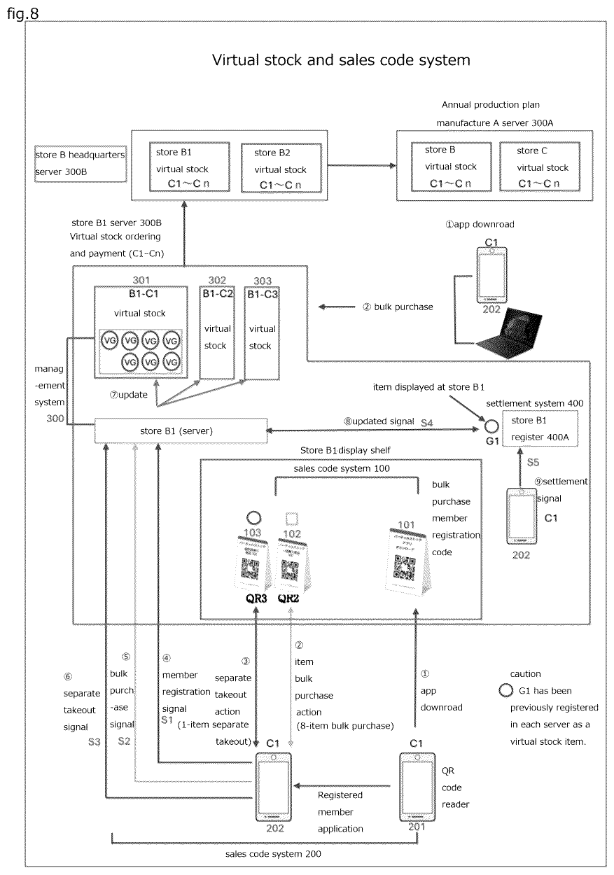

(Example 3) As shown in FIG. 8, the third example of the present invention is based on the membership registration of the commodity G of the customer C and the bulk purchase registration, and not only the store B forms a virtual stock and records the stock, but also the store headquarters B and the manufacturer A, such as a major supermarket having a large number of chain stores B, collect the bulk purchase records from the store B1 to Bn. In this case, although it is the same as the example 1 and the example 2 in that the customer C can bring back the bulk purchase goods G at the bulk purchase unit price in the store B, the Head Office B of the Distributor will be equipped with a server 300B to perform the integrated sales management of each stores of B1 to Bn. The Manufacturer A will be equipped with a server 300A to manage the same data as the Head Office B ofs the Distributor, and perform the integrated manufacturing management of each stores of B1 to Bn, so that the Distributor B Headquarters and the Manufacturer A can collectively receive the virtual stock quantity of the customer C1 to Cn, so that the integrated sales management and the integrated manufacturing management can be performed. Other sales code system 100, the purchase system 200, the settlement system 400 is the same as the example 1 and the example 2, the concerning description thereof is omitted.

As is apparent from the above description, in the case where the manufacturer A manages a large number of distributors B, in the case where the distributor manages a chain stores, and in the case where the distributor and the manufacturer hold the respective management servers, for example, in the case where the distributor and the manufacturer manage the chain stores, but it is possible for the distributor or the manufacturer to manage the entire system with the management server. In both cases, Customer C generally purchases via a store B such as a supermarket, but in the present embodiment, the shop B is trading between manufacturer A and customer C as usual. This is a virtual stock selling method that realizes a selling method in which a large number of products are purchased in a bulk purchase, but the separate items are taken out from the store B without taking all the items out. Since it is integrated and managed in the manufacturer A and the store B, it is not necessary to have actual inventory. The inventory of the mass purchased goods may have a minimum of proper inventory, and the total number managed may be virtual.

When an example of a sales function (retail store B→consumer C) is described by taking an example of a product.

A manufacturer A, a distributor B, and a customer C exist, and the customer C first purchases a detergent sold at the store of the distributor B. Take the detergent sold at 1000 yen per item, and display the same detergent at 500 yen per item with the product and QR code on VS S (Virtuality-Stock-Sellin). After reading the explanation, if you download the app, load QR code QR2, and buy 30 copies on the net in a lump sum, the unit price per copy will drop to 500 yen. I thought it would be a sale on the Internet, and even if 30 units were sent to my house, I was forced to go over my head for a moment because there was no storage space at home. However, if you read the explanation carefully, you only need to buy 30 copies and not to bring all of them back to home, and the remaining 29 copies will be held by Manufacturer A or Distributor B. When necessary, you should come to Distributor B and bring it back as much as you need. I decided to buy 30 of them without hesitation. Then, the detergent displayed in front of the eyes is put into a shopping basket, and the shopping basket is moved to a cash register. Then, it is said that QR code (member application) is requested at the register (corresponding to the identity confirmation), and when the checkout signal S5 displayed from the application is read by the reading device of the register, the virtual inventory of the detergent in the application is subtracted from 30 to 29. Since the product has already been paid, it can be brought home without being added to the purchase price of other products. When using the purchased signal S4 mentioned above, while the inventory of the virtual stock of the manufacturer A or a store B is updated by a member's separate takeout signal S3, and the updated signal S4 is transmitted to the register of the store B and the mobile terminal of the customer C from a virtual stock, this, a personal identification signal (settlement signal S5), and a merchandise check (code QR3 for takeout given to goods) to be distinguished from ordinary products and settled.

Specifically, an example of a purchase function (Manufacturer A→Store or Distributor B)

Distributor B's sales grow 30 times, Until now only one consumer is buying one in a month. While some consumers buy and take out one piece of the bulk purchase as usual, the number of consumers also increases by using VSS, and as the sales of VSS for Manufacturer A is already sold, the price has already been received in advance, so the order can be placed without risking purchasing. However, even in the case of the store B, it is difficult to store 30 times as much inventory as before in the shop and the warehouse, and the inventory is ordered and paid, but the inventory is managed as a virtual inventory by the manufacturer A.

Manufacturer A has already paid for VSS orders, so there is no risk of purchasing raw materials, so it is only necessary to manufacture the shipping amount instead of the sales amount per month of the virtual inventory. Introduction of basic and VSS methods does not increase detergent consumption. In all logistics, the price is changed to be prepaid. There is no need to build a new distribution division because the flow rate does not increase and the flow rate is almost the same as before. Benefits include prepaid payments that eliminate the risks of retailers, brokers, and manufacturers' purchasing of merchandise, as well as the risks of raw materials and manufacturing (excessive inventory).

As can be seen from the above explanation, in the case of normal ordering methods, the number of units sold is predicted and mass-produced. However, in the case of sales below the forecast, the warehouse becomes a mountain of inventory, and in order to reduce the inventory, the price of goods is forced to be cheaper and the deflationary economy is caused. This traditional old ordering method relies heavily on forecasting and has many patterns of high-risk business models. In order to reduce wasteful manufacturing and reduce or eliminate this risk, the inventive VSS approach would lead to a revolutionary, future store retail strategy that can counter online sales. Manufacturer A's direct sale can also be used effectively in the Internet retail business, but has the disadvantage of incurring shipping charges that ultimately direct to the consumer. VSS according to the present invention can only be used by a retailer at the time of first purchasing a product. VSS according to the present invention can only be used by a retailer at the time of first purchasing a product. By placing a large number of VSS products, it also leads to sales promotion, which says that after receiving the products, they shop and go home. In addition, VSS uses the Internet to create a product that can be received at all stores in the group, so that the product can be received by a transfer, a move, a business trip destination, or the like, which is a very convenient way for consumers and leads to sales promotion of the entire group. That is, VSS is an application software that is advantageous to all three parties connecting three parties of a B (business) to B (business) to C (consumer) B to B to C.

### Commodity Identification System at the Time of Settlement

When the management server is used, the manufacturer A and the store B form a virtual stock for each member by membership registration, make a virtual stock in the virtual stock by a bulk purchase contract, and update the inventory quantity by separate takeout, so that a virtual stock separate takeout system can be constructed. However, in order to be distinguished the bulk purchase commodity from the general commodity at the time of settlement of the store B for enabling to do separate takeout, the inventory needs to be updated based on the separate takeout signal S3, and the general commodity and the bulk purchased commodity need to be distinguished from each other by receiving the updated signal S4 from the managing server at the register. In order to identify the commodity, it is required to confirm that the takeout purchaser is a lump-sum purchaser (identity confirmation) and that the takeout commodity is a lump-sum purchased commodity (commodity confirmation) together with the inventory record updated signal S4. Therefore, in the shop register, it is preferable to read the merchandise code and at the same time, read the membership application of the customer portable terminal which has made the bulk purchase, transmit the separate take-out signal S3 to the managing server, receive the inventory record updated signal S4, and identify whether the bulk purchase product or the ordinary product. Customer C can transmit the separate takeout signal S3 prior to settlement at the register to update the inventory record, but in order to prevent malfunction, it is preferable to check the inventory record update by reading the portable application and the product code for identity confirmation at the register again. Therefore, as long as merchandise identification is performed by three checking with 1) the inventory record updated signal S4 replied to a register from a managing server at the same time as 2) personal identification (settlement signal S5) and 3) a merchandise confirmation (bar code QR 3 for takeout), other confirming operations can be used by a register.

### Purchase Price Adjustment System 500

The management server of the manufacturer A shares the data on the virtual stock number N and the virtual stock product number M of the customers C with the management server of the store B, and Nα reduces the wholesale purchase unit price to the store B according to the stock number N and the number of takeout in the store B (where N is the total stock number, and α is the wholesale adjustment price), and returns the purchase price multiplied by the separate takeout number to the store. The purchase price adjustment system is performed by the management server 300A of the manufacturer including an arithmetic unit that performs a purchase price adjustment operation on the basis of the stock number N, the commodity inventory number M, and the number of takeout commodities, and transmitting the wholesale adjustment signal S5 calculated by the arithmetic unit to the management server 300 B of the store B. The specific price adjustment process is shown in FIG. 9.
1) On April 1, Ms. A, after registering as a member, pays 10 lump-sum or bulk purchasing contracts with the retail store at a unit price of 700 yen, pays 7000 yen, and sends a bulk purchasing signal S2, the inventory is formed in the virtual stock on the management server of the retail store, and then, when one take-back signal S3 is sent to the management server of the retail store, the inventory records become 9. The purchase adjustment amount from producer A at this time shall be 0 yen. 2) Then, on April 2, Ms. B made a bulk purchased contract of 10 pieces at a unit cost of 700 yen to the retail store, paid 7000 yen and transmitted the bulk purchased signal S2. When a virtual stock of Ms. B is added to the retail management server and then a single take-home signal S3 is sent to the retail management server, the stock count is 18. At this time, the adjustment of purchase unit price from producer A at this time shall be 50 yen. 3) Furthermore, on April 3, Ms. C made a bulk purchased contract of 10 pieces at a unit cost of 700 yen to retail outlets, paying 7000 yen and transmitting a bulk purchased signal S2. For the management server of the retailer, the number of virtual stocks is increased to three: Ms. A, Ms. B, and Ms. C. On top of that, Ms. C sends a signal S3 as take out signal to the management server of the retailer. If Ms. B brings one of them back, the product number of virtual stocks is 26. At this time, the purchase price from manufactuerer A at this time was set at 88 yen and held the adjusted price is 176 yen multiplied by the number of returnees.

By introduction of a bulk purchase separate takeout system, the above-mentioned adjustment method is very important and How is going to adjust the profits of a store should be determined depending on the difference of goods and so on to adopt the optimal method in view of transition of a selling merchandise, in case that a purchase price between the manufacturer A and the store or retailer B is set up at the same and not distinguished with each other, differs with goods,

As described above, according to the embodiment of the present invention, there can be realized introduction of a bulk purchase separate takeout system, which is not important in the face-to-face sales of the service because an intangible product basically has no inventory, but very important to the bulk purchase of tangible goods because a tangible product basically has inventory. That is, a problem of inventory can be solved and can be eliminated by carrying out the virtual stock system under the identification system to distinguish the bulk purchase goods from the general goods in the register and the purchase price adjustment system for eliminating the risk of reduction of profit in the store, and the new sales method that is useful not only to the consumer C but also to the store B and the manufacturer A. It can be understood that, a person skilled in the art can carry out the modification without departing from the gist “separate take out system of bulk purchase kept in the virtual stock control, with purchase price adjustment system between manufacturer A and the store B by using the membership application and the commodity code read at the store register and the identity authentication and the commodity authentication, and the virtual stock record is updated so that the general commodity is distinguished from the general commodity and the separate take-out is possible from the store ”.

### SIGN DESCRIPTION

100 Sales system
200 purchase system
300 management system
400 settlement system
500 Purchase price adjustment system

1. An individual take-out to home system of one of bulk purchase products kept under virtual stock in a management server from a store where real products are displayed for sales, as needed by a customer, according to a bulk purchase contract made by payment in advance with a manufacturer or a dealer, which comprises a mobile terminal such as a smartphone of the customer, two-dimensional code displays and a management server of the dealer and a management server of the manufacturer, wherein:
the management server of the manufacturer or the dealer is provided with:
a system for receiving a signal S1 for member registration from the mobile terminal of the customer to form the virtual stock for the customer, and
a system for receiving a signal S2 for bulk purchase of the customer via the mobile terminal of the customer to record the bulk purchase product quantity in the virtual stock,
the mobile terminal of the customer is provided with:
a system for reading the two-dimensional code for the product sale of the dealer, and
a system for transmitting a signal S3 for individual take-out of the customer to the management server of the dealer or the manufacturer,
the management server of the manufacturer or the dealer is provided with:
a system for receiving the signal S3 and updating the inventory record of the virtual stock, and
a system for transmitting an inventory record updated signal S4 to a register of the dealer B, and
the register of the dealer is provided with:
a system for confirming the commodity code and the customer ID and collating the commodity code and the customer ID with the inventory record updated signal S4 so as to distinguish the bulk purchase product from any ordinary product for settling up without payment.

2. The individual take-out to home system of one of bulk purchase products kept under virtual stock from a store according to claim 1, wherein the inventory record updated signal S4 is used for an accounting settlement signal S5.

3. The individual take-out to home system of one of bulk purchase products from a store according to claim 1, wherein the commodity code QR3 for taking out is attached to package of the products G1

4. The individual take-out to home system of one of bulk purchase products from a store according to claim 1, which further comprises:
a purchase price adjustment system for returning a purchase price multiplied by an individual take-out number to the dealer, wherein:
the management server of the manufacturer shares data relating to the number of virtual stocks N and the number of virtual stocks M of the customer with the management server of the dealer, and Nα is designed to be reduced from the wholesale purchase unit price to the dealer according to the number of stocks N and the number of takeout in the dealer B, and
N is the total number of stocks, and α is the wholesale adjustment price.

5. The individual take-out to home system of one of bulk purchase products from a store according to claim 1, wherein the managing server of the dealer and the manufacturer share the data about the virtual stock number N and the virtual stock number M of the customer, while the management server of dealer is provided with the system which carries out inventory control of goods by the virtual stock number N and the virtual stock number M of the customer and the management server of the manufacturer is provided with a system which carries out production control of the goods by the virtual stock number N and the virtual stock number M of the customer.

6. The individual take-out to home system of one of bulk purchase products from a store according to claim 1, wherein a dealer head office shares the data from customers C1 to Cn from dealers B1 to Bn instead of or in cooperation with the manufacturer to control a chain of the dealers B1 to Bn.

7. An individual take-out to home system of one of bulk purchase products kept under virtual stock from a store where real products are displayed for sales, which comprises 1) a sales code system 100 at a dealer comprising two-dimensional code consisting of QR code displays 101 and 102, 2) a product purchasing system comprising a mobile terminal, such as a smartphone, 3) a product management system comprising servers 300A and 300B owned by the manufacturer and the dealer, and 4) a product settlement system in a register of the dealer, wherein:
the sales system comprises three types of QR code indications, a member registration code QR 1 for transmitting the signal S1 for performing member registration, a bulk purchase code QR2 for transmitting the signal S2 for performing bulk purchase of goods, and a product individual takeout code QR3 for transmitting a signal S3,
the product purchasing system includes a means for transmitting a signal of a QR code read by a QR code reader to the a mobile terminal owned by a customer, comprising (1) a screen for displaying a membership app icon, which reads the membership registration code QR 1 and acquires by transmitting a membership registration signal S1, (2) a device for reading the membership commodity bulk purchase code QR2 and transmitting a commodity bulk purchase signal S2, and (3) a device for reading the membership individual sales code QR3 and transmitting an individual take-out signal S3,
the managing system comprises the server 300A and/or 300B of the manufacturer and/or the dealer, comprising (4) the virtual stock equipment which receives the member registration signal S1 from the customer, and forms the virtual stocks for every customer, (5) a recording device for recording an inventory of a commodity in the virtual stocks, in response to the bulk purchasing signal S2 of the customer, (6) a device for receiving an individual take-out signal S3, (7) a device for updating an inventory record of the virtual stocks by an individual take-out signal S3, and (8) a device for transmitting an inventory record updated signal S4 of a product to the dealer and the customer terminal, and
the adjustment system at a register, is connected with the server 300A and/or 300B of the manufacturer and/or the dealer, comprising (9) a receiving unit which receives the updated signal S4 from the customer or the manufacturer, and an adjusting device which distinguishes the bulk purchased goods from other common goods in response to the updated signal S4 and excepts the bulk purchased goods from goods settlement-items.

8. The individual take-out to home system of one of bulk purchase products kept under virtual stock from a store according to claim 7, wherein a first QR code display QR1 for transmitting a signal S1 for member registration of the sales system, or a second QR code display QR2 for transmitting a signal S2 for a bulk purchase is obtained via the Internet and is used for performing member registration or member registration and a bulk purchase contract.

9. The individual take-out to home system of one of bulk purchase products kept under virtual stock from a store according to claim 7, wherein the management server 300A of the manufacturer comprises a purchase price adjustment system including an arithmetic unit that performs a purchase price adjustment operation based on the stock number N, the commodity inventory number M, and the number of take-out commodities, so as to transmits the wholesale adjustment signal S5 calculated by the arithmetic unit to the management server 300B of the dealer.
